(19) United States
(12) Patent Application Publication
(10) Pub. No.: US 2016/0120205 A1
(43) Pub. Date: May 5, 2016

(54) PROCESS FOR PRODUCING A CANDY GUM

(71) Applicant: Wacker Chemie AG, Muenchen (DE)

(72) Inventors: Thomas WIMMER, Burghausen (DE); Christian HAUK, Freising (DE); Claudia SCHMIDT, Altoetting (DE); Sandra Maria SCHUCH, Zeilarn (DE); Martin SEIZL, Muenchen (DE)

(21) Appl. No.: 14/885,457

(22) Filed: Oct. 16, 2015

(30) Foreign Application Priority Data
Oct. 30, 2014 (DE) 10 2014 222 198.6

(51) Int. Cl. A23G 4/10; A23G 4/08

(52) U.S. Cl. CPC A23G 4/10; A23G 4/08; A23V 2002/00

(57) ABSTRACT

The invention relates to a one-pot process for producing a candy gum in which a sugar/glucose syrup mixture concentrated by a boiling process, or a mixture of crystalline polyols, or a polyol syrup mixture is mixed with gum base raw materials and also gelling agents, taste agents, and optionally sweeteners, wherein the gum base raw materials used are solely polyvinyl acetate, vinyl acetate-vinyl laurate copolymer, fat, wax and emulsifier.

### BACKGROUND OF THE INVENTION

The invention relates to a process for producing a candy gum.

A candy gum, for the purposes of the present invention, is a product which behaves like a chewing candy in a first chewing phase, and then, in the course of chewing, develops into a chewing gum.

Chewing candies are known in sugar-containing and sugar-free embodiments, belong to the soft caramels and differ from glassy hard caramels which are generally sucked. In connection with the present invention, a chewing candy is taken to mean an article consumed for pleasure or food which, after being taken into the human oral cavity, owing to its flexible structure and consistency, is suitable for chewing, that is to say is deformable, and does not splinter or break under relatively high mechanical loading. Chewing candies are usually produced in a boiling process. In this case, a mixture of sucrose and glucose syrup is boiled with fat and emulsifiers and, in the cooling phase, is admixed with flavorings, edible acids and gelatin solution. The mass is whipped with addition of air, cooled to approximately 30-40° C., and shaped via conical rollers or extruders. In sugar-free chewing candies, sugar and glucose syrup are replaced by a mixture of crystalline polyols and concentrated polyol syrups. Sugar-containing chewing candies in which gelatin can be replaced by wheat gluten are described, e.g., in EP0979611. Sugar-free dragée chewing candies are described in U.S. Pat. No. 6,372,271.

The combination of chewing gum with chewing candy is known. EP 2273891 B1 describes a sugar-free isomalt confection which consists of various layers. A multilayer laminate of a chewing candy layer of a boiled fraction of isomalt, hydrogenated starch hydrolyzate and further constituents with a chewing gum layer is described.

The production of chewing gum from molten crystalline sorbitol or concentrated sorbitol solution is described in U.S. Pat. No. 3,857,965. The gum base is produced in a separate process.

The use of boiled sugar-containing syrup for hard caramels, or sorbitol solution which was concentrated by a boiling process at 180° C. in chewing gum production is taught in U.S. Pat. No. 4,741,905 (examples 2 and 3).

U.S. Pat. No. 8,703,228 (FIG. 1) discloses the separate production of a candy system and a gum base with subsequent mixing of the systems. A disadvantage in all of the technologies mentioned is the separate production of the gum base.

### DESCRIPTION OF THE INVENTION

The object of the present invention is to provide a simplified production process for a candy gum.

The object is achieved by a one-pot process in which a sugar/glucose syrup mixture concentrated by a boiling process, or a mixture of crystalline polyols, or a polyol syrup mixture is mixed with gum base raw materials and also gelling agents, taste agents, and optionally sweeteners, wherein the gum base raw materials used are exclusively one or more of the components polyvinyl acetate, vinyl acetate-vinyl laurate copolymer, fat, wax and emulsifier.

In the process according to the invention a polyol or a polyol mixture, or a mixture of sugar and/or glucose syrup is dissolved in water and concentrated by heating. At the same time or subsequently, polyvinyl acetate, vinyl acetate-vinyl laurate copolymer, fats, waxes and emulsifiers are added.

The mixture is further heated and concentrated until the desired final moisture is obtained in the product.

A sugar-free batch (polyol syrups, polyol solutions) is heated to 120-155° C., preferably at 125-145° C., particularly preferably at 130-140° C.

A sugar-containing batch, that is to say an aqueous solution containing sugar and glucose syrup, is heated to 120-135° C., preferably to 125-133° C.

The desired final moisture in the product is 2% by weight to 8% by weight, particularly preferably 3% by weight to 6% by weight.

After the mass is cooled to 90-110° C. a solution of a gelling agent is added with stirring, and also taste agents, sweeteners and optionally dyes are added. The taste agents are preferably flavorings and edible acids.

Preferably in this case the mixture is stirred for 2 to 10 minutes. Preferably, the temperature is kept constant.

After the mass is cooled to 30-40° C., the mass can be shaped and packaged.

For the molding of the finished mass, familiar processes are available to those skilled in the art, depending on the consistency of the mass: via a cone roller and a drawing machine, a strand can be drawn which runs directly into a cut & wrap packaging machine (simultaneous cutting and packaging), or into an embossing machine. Also rolling and subsequent cutting is possible. A further processing method is extrusion and coextrusion, with which filled products can also be produced. In the case of pourable masses, molding can also proceed in mogul systems in starch powder molds. Alternatively, the masses can be poured into elastic or rigid molds.

If necessary, products can then also be dragée coated, or provided with a chocolate coating (by immersion or spraying processes).

The polyvinyl acetate preferably has a weight-average molecular weight of 10,000-100,000, particularly preferably 10,000-50,000. The weight-average molecular weight Mw was determined by means of size exclusion chromatography (SEC) against a polystyrene standard, in THF at 40° C., flow rate 1.2 ml/min. Mixtures of polyvinyl acetates having differing molecular weight can also be used.

The vinyl acetate-vinyl laurate copolymer is preferably a vinyl acetate-vinyl laurate copolymer having a monomer ratio of 90:10 to 60:40 (% by weight vinyl acetate to vinyl laurate).

The wax is preferably typical waxes as are used in the production of gum base, particularly preferably paraffin waxes and microcrystalline waxes.

The fats are preferably partially or fully hardened vegetable fats and oils, animal fats or milk fat (e.g. butter, cream).

The emulsifier is preferably selected from the group lecithin, glycerol monostearate, acetylated monoglycerides of edible fatty acids, such as acetem and polysorbates.

The gelling agent is preferably gelatin, pectins, agar-agar, gum arabic or starch.

The edible acids are preferably citric acid, tartaric acid, succinic acid, lactic acid or maleic acid.

The sweetener is selected from the group aspartame, acesulfame K, sucralose, cyclamates, neohesperidin, saccharine, Stevia and thaumatin.

The polyols (sugar alcohols) are preferably sorbitol, maltitol, isomalt, mannitol, xylitol, erythritol or lactitol or a mixture of one or more of these substances, some of which are also available as syrups. Particularly suitable are sorbitol, maltitol, isomalt and mannitol or a mixture of one or more of said substances.

The mixture of sugar and glucose syrup preferably has a weight ratio based on dry matter, from 2 to 1, to 1 to 2.

Preferably, the weight ratio of polyols, calculated on a dry basis, to gum base raw materials is in the ratio from 3 to 1 to 1 to 1.

In the case of the sugar-containing variant, the preferred weight ratio of sugar/glucose (calculated on a dry basis) to gum base raw materials is in the range from 3 to 1 to 1 to 1.

The gum base raw materials are preferably used in the weight ratio of polyvinyl acetate (15-40% by weight), vinyl acetate-vinyl laurate copolymers (10-30% by weight), wax (1-20% by weight), fat (10-30% by weight) and also emulsifiers (2-12% by weight), wherein the sum of all the gum base raw materials totals 100%.

The fraction of gelling agents in the finished candy gum is preferably 0.2-3% by weight, of taste agents preferably 0.5-2.5% y weight. Optionally, sweeteners are used at a fraction of 0.05-1.0% by weight.

The process according to the invention only functions when the gum base raw materials used are wax, polyvinyl acetates, vinyl acetate-vinyl laurate copolymer and emulsifiers. If the gum base raw materials used are the otherwise usual (for gum base) raw materials butyl rubber, polyisobutene, colophonium resins, elastomer particles remain, as a result of which the mass cannot be homogenized by a simple stirring element. This is shown in comparative example 1.

The following examples serve for further explanation of the invention:

### Example 1

### Sugar-Free Candy Gum with Strawberry Taste

In a metal vessel, a mixture of 80 g of isomalt and 120 g of sorbitol are mixed with 50 ml of water and concentrated with stirring and temperature elevation until the polyol solution reaches a temperature of 135° C. After addition of 50 g of polyvinyl acetate (VINNAPAS® B 1.5 sp; median molar mass 15,000), 16 g of vinyl acetate-vinyl laurate copolymer (VINNAPAS® B 500/20 VL), 18 g of microcrystalline wax (Penetration 25 mm, melting point 66° C.), 3.5 g of acetem (Grinsted®-Acetem from Danisco), 5 g of glycerol monostearate and 20 g of edible fat (melting point: 32° C.), the mixture is stirred for 20-30 minutes and again heated to 135° C. The homogeneous mass is cooled to 120° C. Then, 10 g of glycerol, 1 g of soybean lecithin and 7 g of triacetin (glycerol triacetate) are stirred in and the mixture is further cooled. At approximately 95° C., a solution of 6 g of gelatin (Bloom: 140) in 10 g of water is added and incorporated into the mixture. Finally, the mass is mixed with 4 g of citric acid, 0.7 g of aspartame and 3.6 g of strawberry flavorings and further cooled. At approximately 30-40° C., the mass is sufficiently firm and can be molded and packaged. The product contains a residual moisture of 4.6%. The resultant product is first chewed like a chewing sweet and on further chewing converts after a few minutes into a chewing gum which is pleasant to chew.

### Example 2

### Sugar-Free Candy Gum with Cherry Taste

40 g of mannitol and 160 g of sorbitol are mixed with 100 ml of water and boiled and concentrated with stirring. At 138° C., 40 g of polyvinyl acetate (VINNAPAS® B 5 sp, median molar mass: 25,000), 25 g of vinyl acetate-vinyl laurate copolymer (VINNAPAS® B 500/20 VL), 20 g of paraffin wax, 4 g of acetem, 6 g of glycerol monostearate and 25 g of edible fat are added and mixed with the boiled syrup. After the mixture is cooled to 115° C., 2 g of soybean lecithin and 5 g of triacetin (glycerol triacetate) are added with mixing, and the mass is further cooled and mixed with a solution of 8 g of gelatin (Bloom: 140) in 15 g of water. After addition of 0.2 g of sucralose, 3.0 g of maleic acid and 5.0 g of cherry flavor, the mass is poured onto a marble slab and kneaded thoroughly. In this case, the mass cools further and can be rolled out into sheets at approximately 35° C. The sheets can be cut into pieces of approximately 4 g. The residual moisture is approximately 3.2%. The product may be chewed with pleasure with good organoleptic properties.

### Example 3

### Sugar-Free Candy Gum with Orange Taste

170 g of maltitol syrup (solids content: 70%) and 170 g of sorbitol syrup (solids content 70%) are boiled with stirring to a temperature of 136° C. and concentrated in the course of this. Then, 35 g of polyvinyl acetate (VINNAPAS® B 1.5 sp, median molar mass: 15,000), 35 g of vinyl acetate-vinyl laurate copolymer (VINNAPAS® B 500/20 VL), 10 g of paraffin wax, 3 g of acetem, 7 g of glycerol monostearate and 32 g of edible fat are added and mixed with the boiled syrup. The mass is cooled to 110° C. and 3 g of soybean lecithin together with 6 g of triacetin are added with stirring. After further cooling to 98° C., 10 g of pectin are added and the mass is aromatized with 7 g of orange oil. After the mixture is cooled, the mass which has solidified as a thin sheet can be cut into strips. The strips, at the start of chewing, have a consistency of a chewing candy. After a chewing time of a few minutes, a good chewing gum is obtained.

### Example 4

### Sugar-Free Candy Gum with “Green Apple” Taste

A mixture of 30 g of mannitol, 57 g of sorbitol syrup (solids content 70%) and 185 g of maltitol syrup (solids content: 70%) are boiled at 140° C. The concentrated syrup is mixed with 30 g of polyvinyl acetate (VINNAPAS® B 1.5 sp, median molar mass: 15,000), 40 g of vinyl acetate-vinyl laurate copolymer (VINNAPAS® B 500/20 VL) and 15 g of microcrystalline wax and stirred for 15 minutes at 130° C. Then, 30 g of edible fat are further added, and also 6 g of acetem are added and the mixture is stirred for a further 5 minutes until a homogeneous mass is formed.

At 120° C., there are further added: 8 g of triacetin, 5 g of glycerol monostearate and 3 g of deoiled lecithin powder. After the mixture is cooled to 100° C., a solution of 8 g of gelatin (140 Bloom) in 16 ml of water is added. Finally, 5 g of “green apple” flavor, 3.5 g of citric acid and 0.4% of aspartame are added with stirring and the mass is cooled to approximately 30° C. The resulting product is first chewed like a chewing candy and converts on further chewing after a few minutes into a chewing gum that is pleasant to chew.

### Example 5

### Sugar-Free Candy Gum with Cola Taste

A mixture of 60 g mannitol and 270 g of maltitol syrup (solids content: 70%) are boiled at 140° C. The concentrated syrup is mixed with 35 g of polyvinyl acetate (VINNAPAS® B 1.5 sp, median molar mass: 15,000), 42 g of vinyl acetate-vinyl laurate copolymer (VINNAPAS® B 500/20 VL) and 10 g of microcrystalline wax and the mixture is stirred for 15 minutes at 130° C. Then, 50 g of edible fat are further added, and also 5 g of acetem, and the mixture is stirred for a further 5 minutes, until a homogeneous mass is formed.

At 115° C., there are further added: 8 g of triacetin, 5 g of glycerol monostearate and 3 g of deoiled lecithin powder. After the mixture is cooled to 100° C., a solution of 6 g of gelatin (140 Bloom) in 12 ml of water is added. Finally, 5 g of “cola” flavor, 4.0 g of tartaric acid and 0.3% of aspartame are added with stirring and the mass is cooled to approximately 30° C. The mass that is cut into pieces chews well and after a few minutes becomes a chewing gum.

### Example 6

### Sugar-Free Candy Gum with Mint Taste

The procedure corresponds to example 1, only the isomalt was replaced by xylitol, and the strawberry flavorings was replaced by a peppermint oil. The resultant candy gum may be chewed well and has a fresh mint taste.

### Example 7

Sugar-Containing Candy Gum with Coffee Flavoring

100 g of sugar are stirred with 180 g of glucose syrup (42 DE) and 35 g of water and brought to a temperature of 133° C. by boiling. Thereafter, 16 g of microcrystalline wax, 4 g of glycerol monostearate, 4 g of acetem, 2 g of soybean lecithin, 15 g of vegetable fat (melting point 32° C.), 40 g of polyvinyl acetate (VINNAPAS® B 1.5 sp, median molar mass: 15,000) and 20 g of vinyl acetate-vinyl laurate copolymer (VINNAPAS® B 500/40 VL) are added, the mixture is homogenized at 125° C. and cooled to 95° C. After addition of 5 g of glycerol, 6 g of triacetin, a solution of 2 g of gelatin (120 Bloom) in 3 g of water and 10 ml of freshly brewed espresso coffee, the mass is stirred for 3 minutes and cooled to 35° C. on a marble slab. The mass which is now solid is cut into bite-size pieces (approximately 3.5 g). The candy gum thus obtained may be chewed first just like a chewing candy and on further chewing converts after a few minutes into a chewing gum that is pleasant to chew.

### Example 8

### Sugar-Containing Candy Gum with Caramel Taste

120 g of sugar, 150 g of glucose syrup (42 DE) and 120 g of cream (30% fat fraction) are boiled until the mixture reaches a temperature of 130° C. Thereafter, 16 g of microcrystalline wax, 3 g of glycerol monostearate, 5 g of acetem, 2 g of lecithin, 20 g of vegetable fat (melting point 32° C.), 50 g of polyvinyl acetate (VINNAPAS® B 1.5 sp, median molar mass: 15,000) and 20 g of vinyl acetate-vinyl laurate copolymer (VINNAPAS® B 500/20 VL) are added and the mixture is stirred at 120° C. until a homogeneous mass is formed. After addition of 10 g of glycerol and 6 g of triacetin, the mass is cooled to 100° C. and a solution of 2 g of gelatin (Bloom 140) in 4 g of water is incorporated. The mass is poured into small molds. After the mixture has cooled, candy gum with good caramel taste is obtained.

### Example 9

### Sugar-Containing Candy Gum from Fruit Syrup

A mixture of 100 g of sugar, 120 g of a commercial fruit syrup (D'Arbo blackcurrant syrup) and 100 g of glucose syrup (42 DE) is boiled at 130° C. Thereafter, 12 g of microcrystalline wax, 3 g of glycerol monostearate, 5 g of acetem, 2 g of lecithin, and 15 g of vegetable fat (melting point 32° C.), 50 g of polyvinyl acetate (VINNAPAS® B 1.5 sp, median molar mass: 15,000) and 20 g of vinyl acetate-vinyl laurate copolymer (VINNAPAS® B 500/20 VL) are added, and the mixture is stirred at 120° C. until a homogeneous mass is formed. After addition of 6 g of glycerol and 6 g of triacetin, the mass is cooled to 100° C. and a solution of 2 g of gelatin (Bloom 140) in 4 g of water is incorporated. After the mixture has cooled, the mass is cut into pieces of 4 g and packaged in waxed candy paper. Again, a candy gum having good taste and pleasant texture is obtained.

### Comparative Example 1

The procedure is analogous to example 1. Usual gum base components are added as individual substances.

In a metal vessel, a mixture of 80 g of isomalt and 120 g of sorbitol is mixed with 50 ml of water and the mixture is concentrated with stirring and temperature elevation until the polyol solution reaches a temperature of 135° C. After addition of 5.4 g of butyl rubber RB 101-3, Lanxess, 5.4 g of polyisobutene (Oppanol® B12 SFN, BASF), 33 g of polyvinyl acetate (VINNAPAS® B 1.5 sp; median molar mass 15,000), 28 g of partially hydrogenated colophonium resin glycerol ester (Eastmann, Staybelite® 5E) and 15 g of microcrystalline wax, the mixture is stirred for 20-30 minutes and in the course of this heated again to 135° C. The mass is cooled to 120° C. Thereupon, 10 g of glycerol, 1 g of soybean lecithin and 7 g of triacetin (glycerol triacetate) are stirred in and the mass is further cooled. At approximately 95° C., a solution of 6 g of gelatin (Bloom: 140) in 10 g of water is added and incorporated into the mixture. Finally, the mass is mixed with 4 g of citric acid, 0.7 g of aspartame and 3.6 g of strawberry flavoring and further cooled.

The mass is not homogeneous, individual elastomer particles are clearly recognizable. The mass disintegrates on chewing, individual particles are clearly unpleasantly detectable.

What is claimed is:

1. A one-pot process for producing a candy gum, said process comprising mixing:
(a) a sugar/glucose syrup mixture concentrated by a boiling process, or a mixture of crystalline polyols, or a polyol syrup mixture;
(b) gum base raw materials;
(c) gelling agents;
(d) taste agents; and optionally
(e) sweeteners;
wherein the gum base raw materials are exclusively at least one member selected from the group consisting of polyvinyl acetate, vinyl acetate-vinyl laurate copolymer, fat, wax and emulsifier.

2. The process as claimed in claim 1, wherein a polyol or a polyol mixture, or a mixture of sugar and/or glucose syrup is dissolved in water and concentrated by heating and at the same time or subsequently polyvinyl acetate, vinyl acetate-vinyl laurate copolymer, fats, waxes and emulsifiers are added, and the mixture is further heated and concentrated until a desired final moisture is obtained in a product thereof.

3. The process as claimed in claim 1, wherein the polyvinyl acetate has a weight-average molecular weight of 10,000-100,000, and the vinyl acetate-vinyl laurate copolymer is a vinyl acetate-vinyl laurate copolymer having a monomer ratio from 90:10 to 60:40.

4. The process as claimed in claim 1, wherein a sugar-free batch is heated to 120-155° C., or a sugar-containing batch is heated to 120-135° C.

5. The process as claimed in claim 1, wherein a desired final moisture in the product is 2% by weight to 8% by weight.

6. The process as claimed in claim 1, wherein a resultant mass is cooled to 90-110° C. and then a solution of a gelling agent and also taste agents, sweeteners and optionally dyes are added with stirring.

7. The process as claimed in claim 6, wherein the taste agents are flavorings and edible acids.

8. The process as claimed in claim 6, wherein the stirring is conducted for 2 to 10 minutes at a constant temperature.

9. The process as claimed in claim 6, wherein a finished mass obtained is cooled to 30-40° C., shaped and packaged.

10. The process as claimed in claim 2, wherein the polyvinyl acetate has a weight-average molecular weight of 10,000-100,000, and the vinyl acetate-vinyl laurate copolymer is a vinyl acetate-vinyl laurate copolymer having a monomer ratio from 90:10 to 60:40.

11. The process as claimed in claim 10, wherein a sugar-free batch is heated to 120-155° C., or a sugar-containing batch is heated to 120-135° C.

12. The process as claimed in claim 11, wherein a desired final moisture in the product is 2% by weight to 8% by weight.

13. The process as claimed in claim 12, wherein a resultant mass is cooled to 90-110° C. and then a solution of a gelling agent and also taste agents, sweeteners and optionally dyes are added with stirring.

14. The process as claimed in claim 13, wherein the taste agents are flavorings and edible acids.

15. The process as claimed in claim 14, wherein the stirring is conducted for 2 to 10 minutes at a constant temperature.

16. The process as claimed in claim 15, wherein a finished mass obtained is cooled to 30-40° C., shaped and packaged.

17. The process as claimed in claim 16, wherein the weight-average molecular weight of the polyvinyl acetate is 10,000 to 50,000.

18. The process as claimed in claim 3, wherein the weight-average molecular weight of the polyvinyl acetate is 10,000 to 50,000.
